(19) United States
(12) Patent Application Publication
(10) Pub. No.: US 2002/0091620 A1
(43) Pub. Date: Jul. 11, 2002

(54) Method and system for international trade through the internet

(76) Inventor: Alan Lin, Taipei (TW)

Correspondence Address: BAKER & BOTTS, 30 ROCKEFELLER PLAZA, NEW YORK, NY, 10112

(21) Appl. No.: 09/894,685

(22) Filed: Jun. 28, 2001

(30) Foreign Application Priority Data
Jan. 10, 2001 (TW) 90100571

(51) Int. Cl. G06F 17/60

(52) U.S. Cl. 705/37

(57) ABSTRACT

A method and system for international trade through the Internet is disclosed. The web site of the present invention is connected, and the buyer selects products he wants to buy and then selects specifications, such as shipping company, insurance company, and inspection company. An order form according to the selected products and selected specification is produced. The buyer may send said order form to the trade server of the present invention. Then the trade server sends said order form to the relative supplier.

### FIELD OF THE INVENTION

This invention relates to a method and system for business, and specifically relates to a method and system for international trade via the Internet.

### BACKGROUND OF THE INVENTION

Internet technology has changed the conventional business model from face-to-face trading to via Internet trading, especially for the developments of multimedia that support the developments of electronic-commerce (e-commerce). This kind of trading via the Internet has become the trend. The high tech companies in the world also develop e-commerce to catch business benefit. Therefore, the business will be combined with the Internet to obtain the maximum profit in the future.

The information provided through the Internet often only includes the products or services coming from that specific information provider. The customers must connect to a variety of different providers' web sites in order to search for products and services they want. They must also compare prices at these different web sites for those products or services that they want to purchase. This whole business process would take a lot of time to finish. It is obvious that the current information distribution system on the Internet lacks flexibility to sufficiently meet each user's needs.

The international trade process not only involves the production trading expenses, but also the cost of phone and faxes, insurance expenses, banking expenses, and inspection expenses. The involved business field thus includes not only the manufacturer but also the banking, shipping, and insurance. A buyer usually processing an international trade via the Internet often needs to search a specific business field to get a specific vender. For example, if a product is provided by many venders, the buyer needs to connect every vender's web sit to record the products price and compare the price to all the other venders' prices to get the best cost. If the product needs be shipped, the buyer needs search the shipping provider via the Internet. If the product needs to be insured, the buyer needs to search for the insurance provider via the Internet, again. It will take a lot of time for the buyer to search all of these services via the Internet.

Some product prices will be fluctuant due to the seasonal and the international situation. For example, the increase of oil prices and insurance premiums due to a tense international situation may cause the increase of shipping and insurance prices. Therefore, the vendors may require a convenient way to update the product price and broadcast the updated price message to their customers. The buyer may then calculate the total cost and make cost-benefit analysis.

### SUMMARY OF THE INVENTION

According to the above background of the invention, special companies or industries only provide conventional international trade, through the Internet. Many problems exist though. For example, the price shown on the web site is only the quotation price given by the web site owner. The buyer needs to spend a lot of time to connect to different web sites to get all the quotation prices they want, which could change the advantage of trading over the Internet. However, international trade also involves shipping and insuring the product, therefore, if the web site only provides information on the product without providing information on shipping, insurance, etc. Therefore, the customer may choose not to continue processing an order and trade internationally by using that web site.

It is therefore an objective of the present invention to provide a method and system for international trade via the Internet to save the time of buyer and seller . It is another objective of the present invention to provide a kind of interaction trade method through the Internet, which may provide a convenient business environment and eliminate the complicated process of making a manual order.

According to the above objectives, the present invention discloses a method for international trade via the Internet, which comprises the steps of connecting to the present invention's web site, using the Internet, to start the international trade buying process. The next step is to select the manufacturer, in this step, the web site of the present invention will provide a quotation of prices of the manufacturer selected, wherein the quotation of prices is provided by many companies not just by one company. Therefore, the customer may compare the price to choose the best one. The customer is also able to negotiate the price with supplier directly through the present invention. After finishing the selection, the customer may select the shipping company and insurance company. The present invention's web site provides many shipping and insurance suppliers for customers to choose compare in this step. After finishing these two steps, the web site may provide an order form, and the customer can check the order form and obtain the total cost. If the buyer accepts the total cost, the trading server system may send the order form to the product's company, shipping company, insurance company, etc. The process of electric transaction follows the order form.

The present invention also discloses a system for international trade, which comprises a client computer which consists of a CPU, memory, display, input device, and an Internet apparatus for connecting to Internet to send an order form to a trading server. A trading server links to the client's computer and supplier's computer respectively. The trading server receives an order form from the client's computer and sends the order form to the supplier's computer. However, the supplier may also renew the quotation of prices on the web site by sending the latest price to the trading server through the Internet. The trading server also provides a negotiation system, the buyer therefore may also negotiate with the supplier through the Internet. Internet links with the client's computer, trade server and supplier computers.

### BRIEF DESCRIPTION OF THE DRAWINGS

For a more complete understanding of the invention, references are made to the following Detailed Description of the Preferred Embodiment taken in connection with the accompanying drawings in which:

FIG. 1 is a functional block diagram illustrating an international trade system of the present invention;

FIG. 2 is a flow chart illustrating the trading through the Internet of the present invention;

FIG. 3 is a process illustrating the trading through the Internet of the present invention;

FIG. 4 is a flow chart illustrating the suppliers renewed price through the Internet of the present invention;

FIG. 5 shows an interface illustrating the shipping company renewing the price through the Internet of the present invention; and

FIG. 6 shows an interface illustrating the insurance company renewing the price through the Internet of the present invention

### DETAILED DESCRIPTION OF THE PREFERRED EMBODIMENT

Without limiting the spirit and scope of the present invention, the method proposed in the present invention is illustrated with one preferred embodiment about the international trade through the Internet. People who are knowledgeable about the embodiments, can apply the present invention to different Internet trading systems to increase convenience. The supplier may update the price anytime. The buyer thus may get the latest consumption cost. It may eliminate the disadvantage of the conventional Internet trading systems need to connect to different web site for completing the whole transaction process.

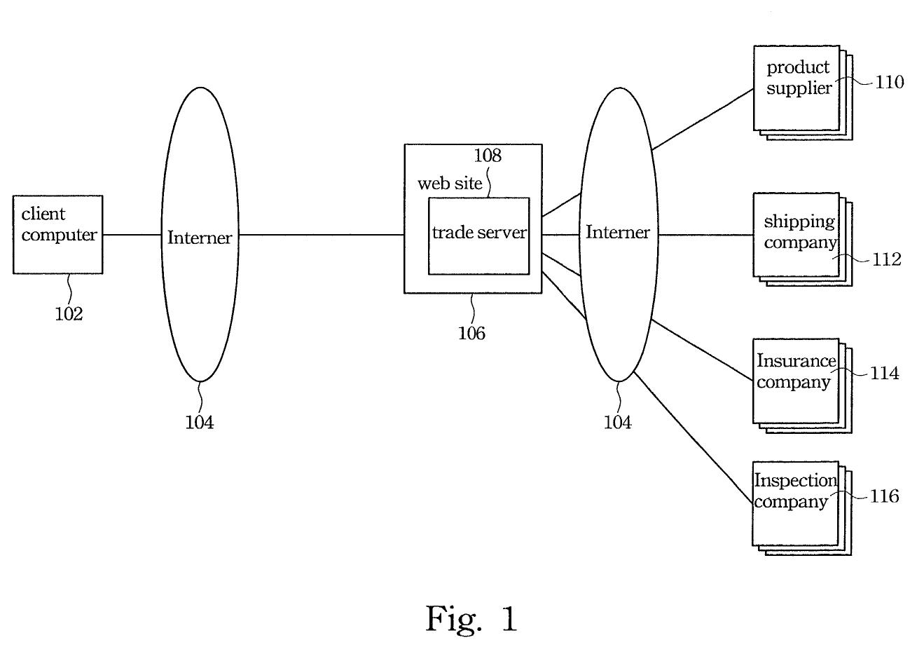

The present invention discloses a method and system to solve the disadvantage of conventional Internet trading. FIG. 1 is a functional block diagram illustrating an international trade system of the present invention. The international trade system over the Internet consists of client computer 102, web site 106 of the present invention having a trade server 108, Internet 104, product supplier 110, shipping company 112, insurance company 114 and inspecting company 116.

The client computer 102 consists of a CPU, memory, display, input apparatus and Internet apparatus, wherein the CPU links with the memory, display, input apparatus and the Internet apparatus respectively. The CPU is the controller of the client computer 102 to send and receive the trade instruction from the web site of the present invention. The memory stores the web site program. The display shows the trade process. The client computer may use the Internet apparatus to connect with the Internet to send an order form.

Client computer 102 may use the Internet apparatus to connect with Internet 104, and enter web site 106 of the present invention to process trading. Wherein web site 106 comprises the latest news about products, the introduction segment of the cooperation company, registration segment and other help function keys, such as the products introduction, the web site guiding and use menu, the latest news, and customer service. The customer may use the customer service function to connect to the service person through the Internet directly to solve the problem.

Trade server 108 may use Internet 104 to link with client computer 102 and the suppliers respectively, such as product suppliers 110, shipping companies 112, insurance companies 114, and inspection companies 116, etc. The trade server having a decoding apparatus to decode the order form. The trade server may send the order form to the supplier. For example, if the supplier has confirmed the order form, then the order form may be sent to web site 106 through Internet 104. At this point, through, the Internet, trade server 108 will send the product order form to the product supplier. this information is then sent with the shipping data and the needed size of transportation container to shipping company 112. The required insurance and inspection is then sent to insurance company 114 and inspection company 116 respectively. These suppliers may also send the latest news about the shipping data change, the new type product, and the price through the Internet to trade server 108 to update the information displayed by web site 106, which may help the buyer control the latest cost.

Internet 104 is responsible for transmitting informational links with client computer 102, trade server 108 and the suppliers, such as the product suppliers 110, the shipping companies 112, the insurance companies 114 and the inspection companies 116. Trade server 108 may send the order form to the suppliers and receive the updated information from the suppliers through the Internet.

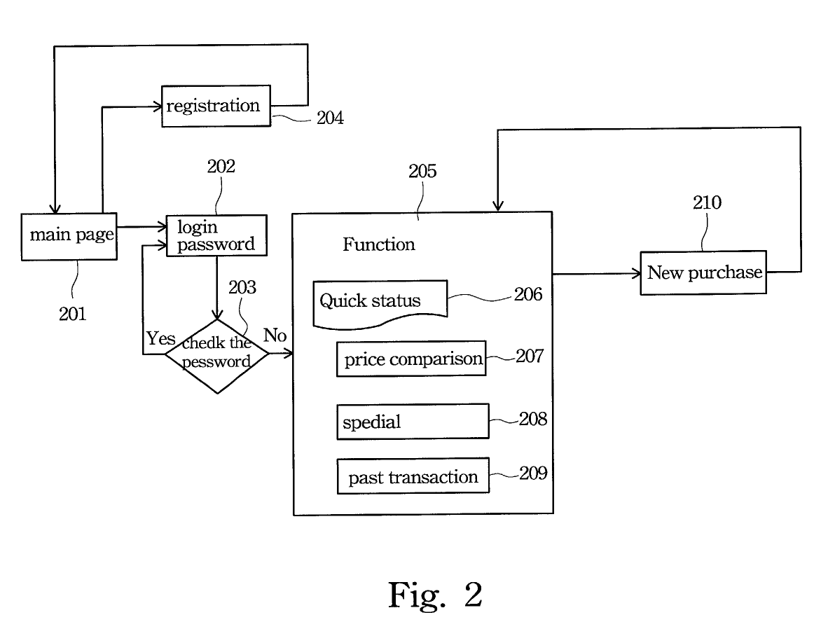

Referring to FIG. 2 it depicts trading through the Internet of the prefered embodiment of the present invention. The client's computer is connected to the main page of the present invention's web site through the Internet to start a trade process at step 201, then, login using a password at step 202. At this point, the present invention's trade system will check the password at step 203, if the password is wrong, the trade processing will come back to step 202 and require a person to enter the password again. However, if the password is correct, the trade process may continue to the next step. The customer who does not have a password will be required to become a member of the present invention's web site at step 204. The computer will then go back to step 204 to register in order to start the trade processing. The trade process will continue to function to menu 205 after the login process of the web site. In function menu 205, the customer may select the “Quick Status” function 206, the “Price Comparison” function 207, the “Special” function 208 and the “Past Transaction” function 209. The “Quick Status” function 206 helps the customer to review detailed information of purchased product, such as the total quantity, the unit and total cost, and updates of the order status, such as the payment situation and whether the vessel departed from the port of origin, etc. Function menu 205 also provides a “Help” function. The buyer may contact the service center over the Internet through the “Help” function. The “Price Comparison” function 207 is designed to lower the transaction cost in the procurement process. No more countless phone calls and faxes to inquire prices from various suppliers. All the customer simply select the product and specifications that the customer wants to buy, and instantly different prices are offered by different individual suppliers are shown on the screen simultaneously. The “Special” function 208 provides specified priced products, updates on new products and new messages offered from the suppliers. In the “Special” function, the customers may also post messages to communicate with the suppliers directly if they have questions or comments concerning the promotion of new products offered. The buyer may obtain the latest product information through the “Special” function as well. The “Past Transaction” function 209 displays a detailed record of the previous transaction with the present invention's web site. This serves as a reference to the customer. The customers may select the “New Purchase” function to begin a new purchase processing at step 210. The detailed information of the purchased product will be shown on the “Quick Status” function 206 after a new purchase.

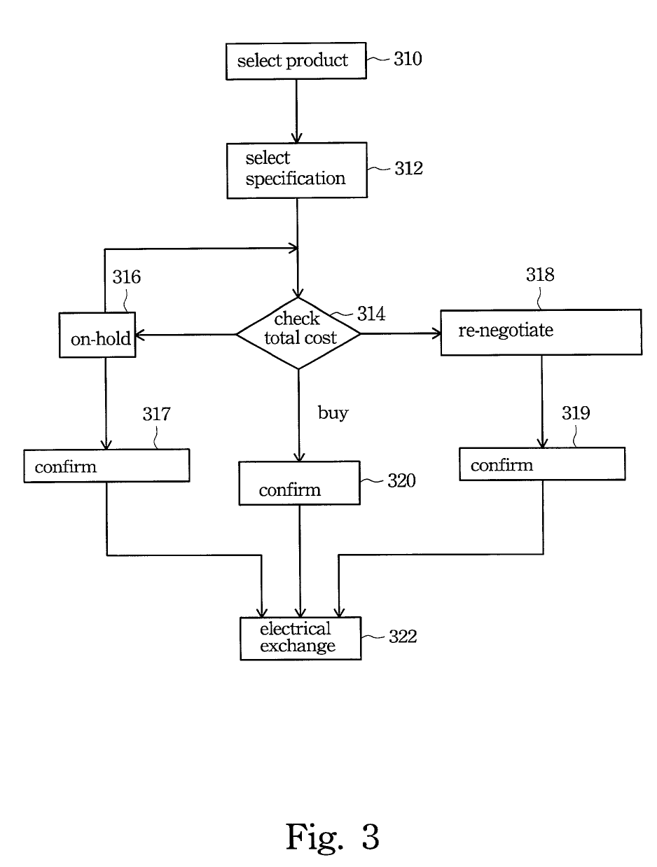

The new purchase process is illustrated in FIG. 3. The buyer may place their order on the new purchase process. After entering the new purchasing web page, the buyer will see a list of products offered by different individual suppliers, and the buyer may check the product name, price and special offers. The buyer can also select to process a “Multiple Buy” or a “Single Buy”. Then, the buyer selects the product at step 310. The buyer may contact with the service center over the Internet directly if they have any problems regarding the product items. Then, the buyer may select the preferred shipping company, insurance company and inspection company at step 312. Next, the buyer may check the total cost according to the selected product and relative shipping, insurance, and inspection company at step 314. The buyer may confirm the final order form at step 320 if accepting the total cost and confirming the advanced shipping and payment terms, such as partial shipment, etc. The final order form comprises of the product name, quality, unit price, and total price. This detailed product information form will automatically be transferred to the “Quick Status” function 206. The electrical exchange will be processed at step 322. The trade server will notify the shipping company, insurance company, and inspection company through the Internet, respectively, after the buyer confirms the final order form. At this point, the international trade process through the present invention's web site will be finished. This eliminates the disadvantage of conventional trade over the Internet by not having to connect to different web sites to select different services, such as shipping, insurance, and inspection, etc.

Furthermore, the web site of the present invention provides a “Re-Negotiate” function for the buyer to purchase products according to the setting cost. The buyer may negotiate with the supplier directly over the Internet through the web site of the present invention at step 318 if the total cost is not accepted. At this point the customer may communicate with the supplier over the Internet. The buyer may enter questions, comments or counter bids. The buyer may confirm the negotiated price on the order form, if the supplier accepts the counter bid at step 319, then the web site processes an electrical exchange at step 322. Furthermore, the buyer also can select the “On Hold” function. “On Hold” means the order will be aggregated for best possible pricing. Then, the buyer announces that the products price may be accepted over the Internet. The present invention's trade sever will notify all suppliers of the product price the buyer accepted. The buyer may confirm the “On Hold” order form if the supplier accepts the notified product price at step 317, then the web site processes an electrical exchange at step 322. The “On Hold” has another function, it is to process a future purchase. If the buyer accepts the product's price and confirms the final order form at step 320, then the buyer may process an electrical exchange at step 322.

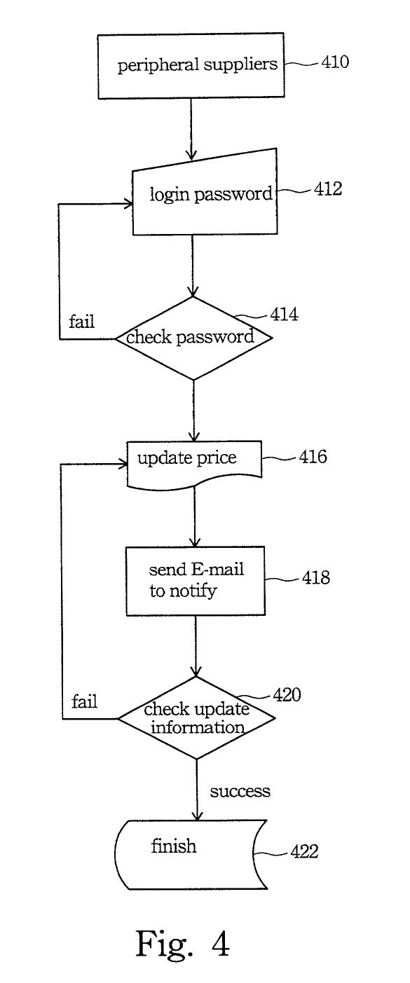

The best advantage of the present invention's web site is to provide the peripheral suppliers, such as product suppliers, shipping companies, and insurance companies, etc, with updated prices and information through their computers. Then, the updated prices and information are sent to the present invention's trade server through the Internet. FIG. 4 is a flow chart of the present invention illustrating the suppliers renewed prices through the Internet. The peripheral suppliers connect to the main page of the present invention's web site to begin updating prices and information processing at step 410, then, a person must type in their password at step 412. At this point, the present invention's trade system will check the password at step 414, if the password is wrong, the updated process will automatically come back to the step 412 and require a person to enter in their password again. If the password is correct, the process may continue to the next step 416 to begin updating the price and information. The peripheral suppliers may send an E-mail to the present invention's web site in order to notify the work has been finished at step 418 after finishing the updated work. At this point, the web site of the present invention will confirm the updated information again to guarantee that the information is correct at step 420. The updating process is finished at step 422 if the updated information is correct.

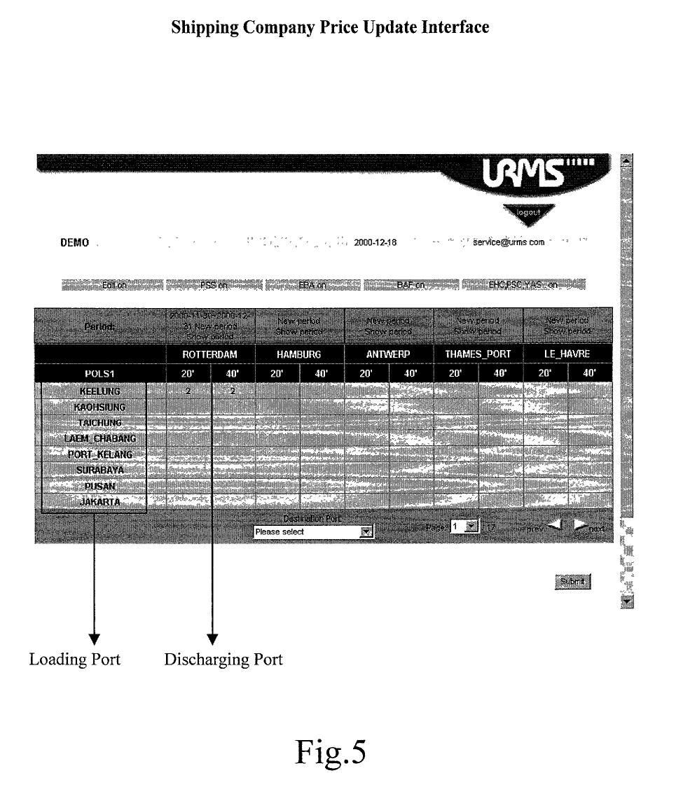

FIG. 5 shows an interface illustrating the shipping company renews the prices through the Internet of the present invention. For example, the fluctuation of transportation charges is related to the fluctuation of oil price. Therefore, the shipping company may update the transportation charges immediately according to the oil price fluctuation through the interface. However, the shipping company may provide customers with the latest company news or special offers through the Internet.

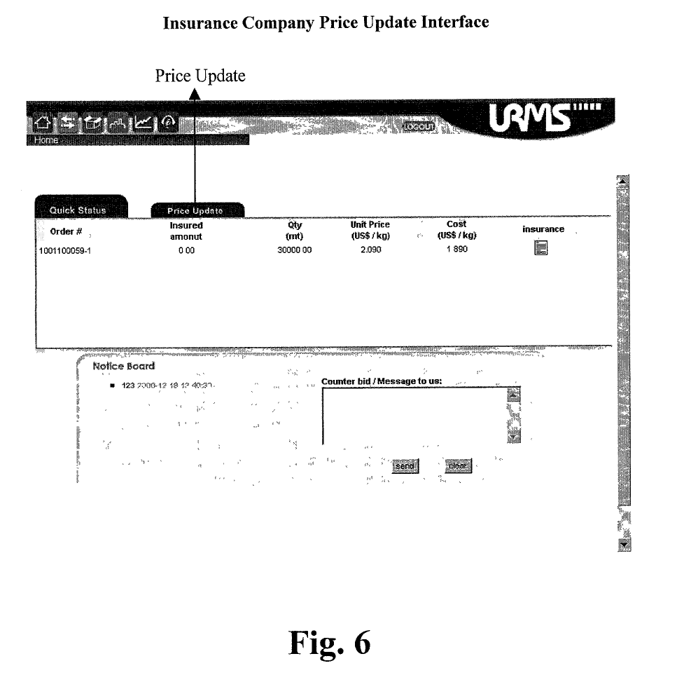

FIG. 6 shows an interface illustrating the insurance company renews the price through the Internet of the present invention. The fluctuation of insurance premiums is effected by the international situation. Therefore, the insurance company may update the insurance premium immediately according to the international situation. However, the insurance company may provide its customers the latest company news or special offers through the Internet.

The present invention provides the following advantages:

(1) The buyer processing international trade through the present invention's web site may save a lot of time because the present invention may eliminate the disadvantage of conventional method of doing trade over the Internet. The conventional way meaning having to connect to different web sites to select different services, such as shipping, insurance, and inspection, etc.Futhermore, the supplier may update information through the Internet and, therefore, the method and system of the present invention may create profit for both.

(2) The buyer connects to the present invention's web site and selects the product and specifications the buyer wants to buy, then confirms the order form. The web site of the present invention may automatically send the order form to the suppliers respectively, which may eliminate the process being done by hand. Therefore, convenience is increased.

(3) The cost, including the product inquiring cost, service cost, and mailing cost, may be reduced by using the method and system of the present invention because E-mail is used. Furthermore, the supplier may update the product's price immediately through the Internet if the product's price changes. Therefore, the buyer does not need to connect to different web sites to know the latest cost and special offer.

(4) The buyer does not need to remember a lot of web site addresses of companies.

To summarize the present invention, the Method and System for International Trade through the Internet may save cost, flexible message access, tight connection between e-companies and customers for creating huge opportunity for profit. The information transmission efficiency over cyberspace has also improved.

Although the invention has been described in detail herein, with reference to its preferred embodiment, it is to be understood that this description is by way of example only, and is not to be interpreted in a limiting sense. It is to be further understood that numerous changes in the details of the embodiments of the invention can occur, and additional embodiments of the invention, will be apparent, and may be made by, persons of ordinary skill in the art having reference to this description. It is considered that such changes and additional embodiments are within the spirit and true scope of the invention as claimed below.

We claim:

1. A computer implemented method for international trade through the Internet, the method comprising:
connecting to the Internet, using an Internet connector to connect said international trade web site to process trade;
selecting products in a purchasing page of said web site;
selecting specification according to said selected products;
producing an order form according to said selected products and said selected specification, wherein said order form includes product name, quality, unit price and total price;
checking said order form to confirm whether said selected products and selected specification is correct; and
sending said order form to said web site after confirming said order form, wherein said web site will send said order form to suppliers respectively to process an electrical exchange.

2. The method of claim 1, wherein the step of checking said order form further includes if the total price is out of the budget, the buyer may negotiate with the product supplier through the Internet directly.

3. The method of claim 1, wherein the step of checking said order form further includes if the total price is out of budget, the buyer may set said order form being on-hold and post the price being accepted to the suppliers through the Internet. In response to a determination that said price been accepted by a supplier, returning to checking order form step.

4. The method of claim 1, wherein the step of selecting specification means to select the specification for shipping, insurance, inspection and banking.

5. The method of claim 1, wherein said web site will send order form to suppliers respectively means to send the order form to the suppliers that produce the production the buyer wanted.

6. The method of claim 1, wherein said purchase page further includes the web page of product price comparison.

7. The method of claim 1, wherein said order form comprises the product name, quality, unit price, specification and total price.

8. A computer implemented system for international trade through the Internet, the system comprising:
a client computer which may use an Internet connector to connect the Internet to process trade and send an order form;
a trade server linking with said client computer to receive said order form sent by said client computer;
a plurality of suppliers' computers linking with said trade server to receive said confirmed order form; and
an Internet linking with said client computer, said trade server and a plurality of suppliers computer.

9. The system of claim 8, wherein said trade server may send said order form to relative supplier after confirming said order form.

10. The system of claim 8, wherein said supplier's computer may send update message to said trade server when message changing.

11. The system of claim 10, wherein said trade server may automatically update the received message from said supplier computers.

12. The system of claim 10, wherein said message further comprises new product message and special offer.
